(19) United States
(12) Patent Application Publication
(10) Pub. No.: US 2026/0229404 A1
(43) Pub. Date: Aug. 6, 2026

(54) EXTRUSION COMPRESSION MOLDED CRITICAL RARE EARTH FREE BONDED PERMANENT MAGNET

(71) Applicants: UT-Battelle, LLC, Oak Ridge, TN (US); Iowa State University Research Foundation, Inc., Ames, IA (US); University of Tennessee Research Foundation, Knoxville, TN (US)

(72) Inventors: Mariappan Parans Paranthaman, Knoxville, TN (US); Uday Kumar Vaidya, Knoxville, TN (US); Haobo Wang, Knoxville, TN (US); Kaustubh Vidyadhar Mungale, Knoxville, TN (US); Harshida Parmar, Ames, IA (US); Xubo Liu, Ames, IA (US); Cajetan Ikenna Nlebedim, Ames, IA (US); James W. Kemp, Knoxville, TN (US)

(21) Appl. No.: 19/532,128

(22) Filed: Feb. 6, 2026

Related U.S. Application Data
(60) Provisional application No. 63/754,757, filed on Feb. 6, 2025.

(51) Int. Cl. H01F 41/02; C08K 3/28; C08L 77/02; H01F 1/057

(52) U.S. Cl. CPC H01F 41/0266; C08K 3/28; C08L 77/02; H01F 1/0578; C08K 2201/01

(57) ABSTRACT

A method of fabricating a high energy density bonded magnet is provided. The method includes combining a critical rare earth free magnetic material with a polymeric material to obtain a mixture. The method further includes extruding the mixture, and compression molding the extruded mixture to obtain a compression molded product. The critical rare earth free magnetic material may include Sm₂Fe₁₇N₃ (Sm—Fe—N) in a content of at least 95 wt. %. The polymeric material may include one or more of a polyamide, a polycarbonate, a polyphenylene sulfide, a polyether ether ketone, a polyurethane, a polytetrafluoroethylene, a thermoplastic elastomer, a polyvinyl chloride, and polyethylene. A high energy density bonded magnet formed by the method is also provided. The high energy density bonded magnet may have a maximum energy product (BHₘₐₓ) of at least 20 MGOe.

### CROSS-REFERENCE TO RELATED APPLICATIONS

This application claims the benefit of U.S. Provisional Application No. 63/754,757, filed Feb. 6, 2025, the disclosure of which is incorporated by reference in its entirety.

### STATEMENT REGARDING FEDERALLY SPONSORED RESEARCH AND DEVELOPMENT

This invention was made with government support under Contract No. DE-AC05-000R22725 and Contract No. DE-AC02-07CH11358 awarded by the U.S. Department of Energy. The government has certain rights in the invention.

### FIELD OF THE INVENTION

The present invention relates to a method of manufacturing bonded permanent magnets.

### BACKGROUND OF THE INVENTION

Samarium iron nitride alloys (Sm₂Fe₁₇N₃; Sm—Fe—N) represent an important class of anisotropic magnets with high magnetic strength ((BH)ₘₐₓ of ~286 kJ·m⁻³), Curie temperature (476° C.), and uniaxial anisotropy (K_{f}=8.6 MJ·m⁻³). Although Sm—Fe—N exhibits magnetic properties at par with Nd—Fe—B, it has processing challenges due to instability of the nitride at high temperatures. Sm—Fe—N decomposes at 600° C., resulting in the loss of hard magnetic properties, thus eliminating a sintering process as a method of production. Liquid phase sintering is a stable method to process Nd—Fe—B. In fact, liquid phase sintering offers advantages such as formation of a Nd-rich low-melting phase, which isolates the Nd—Fe—B grains from each other during post-sintering heat treatment and leads to improved coercivity. To enable the use of liquid phase sintering for Sm—Fe—N magnets, addition of various Sm-based eutectic alloys (Al, Cu, Zn, Fe as metal binders) to the Sm—Fe—N compound have been used to lower the sintering temperatures and retain the hard magnetic properties.

Sm—Fe—N powders can be granulated to 1-5 μm without the loss of coercivity, unlike Nd—Fe—B in which coercivity degrades when milled to below 100 μm. Sm—Fe—N is also advantageous when used as a bonded magnet, with higher coercivity and corrosion resistance, compared to Nd—Fe—B bonded magnets. However, a need continues to exist for improved manufacturing methods for producing Sm—Fe—N bonded magnets.

### SUMMARY OF THE INVENTION

A method of fabricating a high energy density bonded magnet is provided. The method includes combining a critical rare earth free magnetic material with a polymeric material to obtain a mixture. The method further includes extruding the mixture, and compression molding the extruded mixture to obtain a compression molded product.

In specific embodiments, the critical rare earth free magnetic material comprises Sm₂Fe₁₇N₃ (Sm—Fe—N).

In specific embodiments, the polymeric material comprises a polymer.

In particular embodiments, the polymer is a polyamide.

In certain embodiments, the polyamide is nylon 12.

In particular embodiments, the polymer is polycarbonate, polyphenylene sulfide, polyether ether ketone, polyurethane, polytetrafluoroethylene, thermoplastic elastomers, polyvinyl chloride, or polyethylene.

In specific embodiments, the polymeric material is a hybrid material including a polymer and a magnetic material.

In particular embodiments, the magnetic material is Sm₂Fe₁₇N₃ (Sm—Fe—N).

In specific embodiments, the mixture has a content of magnetic material that is at least 95 percent by weight (wt. %).

In particular embodiments, the content of magnetic material is approximately 95 wt. %.

In particular embodiments, the content of magnetic material is approximately 97 wt. %.

In specific embodiments, the method further includes annealing the compression molded product in a magnetic field.

In particular embodiments, the magnetic field has a magnetic flux density of up to 5T.

In certain embodiments, the magnetic field has a magnetic flux density of approximately 3T.

In specific embodiments, the compression molded product has a maximum energy product (BHₘₐₓ) of at least 20 MGOe.

In particular embodiments, the compression molded product has a maximum energy product (BHₘₐₓ) of at least 23 MGOe.

In certain embodiments, the compression molded product with post-magnetic field annealing has a degree of alignment (DoA) of at least 90%.

In certain embodiments, the compression molded product with post-magnetic field annealing has a degree of alignment (DoA) of at least 99%.

A high energy density bonded magnet formed by the method is also provided.

These and other features of the invention will be more fully understood and appreciated by reference to the description of the embodiments and the drawings.

### BRIEF DESCRIPTION OF THE DRAWINGS

FIG. 1 is a graph of X-Ray Diffraction (XRD) patterns of high energy density bonded magnets in accordance with embodiments of the disclosure;

FIG. 2 is a graph of thermogravimetric analysis (TGA) measurements of the high energy density bonded magnets;

FIG. 3 is a graph of magnetic hysteresis loops of the high energy density bonded magnets;

FIG. 4 is a graph of magnetic field dependent Degree of Alignment (DoA) measurements of the high energy density bonded magnets;

FIG. 5 is a graph of magnetic field dependent coercivity (H_{c}) and remanence (Mᵣ) measurements of the high energy density bonded magnets;

FIG. 6 is a graph of temperature dependent coercivity (H_{c}) and remanence (Mᵣ) measurements of the high energy density bonded magnets;

FIG. 7 is a graph of temperature dependent energy product ((BH)ₘₐₓ) of the high energy density bonded magnets; and

FIG. 8 is a graph of low temperature dependent second quadrant M-H measurements of the high energy density bonded magnets.

### DETAILED DESCRIPTION OF THE CURRENT EMBODIMENTS

A method of fabricating a high energy density bonded magnet is provided. The method includes combining a critical rare earth free magnetic material with a polymeric material to obtain a mixture, extruding the mixture, and compression molding the extruded mixture to obtain a compression molded product. The steps of the method are described in detail below.

The method first includes combining a critical rare earth free magnetic material with a polymeric material to obtain a mixture. Particularly, the critical rare earth free magnetic material and the polymeric material are mixed in a batch mixer. The batch mixer may be of the type that includes a mixer bowl, counter-rotating blades, and a temperature control system. The batch mixer also may be capable of maintaining an inert atmosphere, such as, for example, by enclosing the mixer bowl in a sealed enclosure and providing a continuous flow of nitrogen gas to the enclosure. The polymeric material is melted by raising the temperature of the mixer bowl and/or surrounding environment in the batch mixer using the temperature control system. Critical rare earth free magnetic material, which may be in the form of a powder, is then added to the mixer bowl and allowed to disperse in the melt. The powder may have a grain size in the range of 1 to 5 μm. The resulting mixture is a melt including the critical rear earth free magnetic material dispersed in the polymeric material.

In various embodiments, the critical rare earth free magnetic material comprises, consists of, or consists essentially of Sm₂Fe₁₇N₃ (Sm—Fe—N). In specific embodiments, the critical rare earth free magnetic material is pure Sm₂Fe₁₇N₃ (Sm—Fe—N) or Sm₂Fe₁₇N₃ (Sm—Fe—N) with trace impurities. The critical rare earth free magnetic material does not include or essentially does not include (with the possible exception of trace impurities) any critical rare earth elements, such as, for example, neodymium, dysprosium, europium, terbium, and/or yttrium. The polymeric material comprises, consists of, or consists essentially of one or more polymers. In specific embodiments, the polymer is a polyamide, such as, but not limited to, nylon 12. In other embodiments, the polymer is polycarbonate, polyphenylene sulfide, polyether ether ketone, polyurethane, polytetrafluoroethylene, thermoplastic elastomers, polyvinyl chloride, or polyethylene. In yet other embodiments, the polymer is a combination of one or more of a polyamide, a polycarbonate, a polyphenylene sulfide, a polyether ether ketone, a polyurethane, a polytetrafluoroethylene, a thermoplastic elastomer, a polyvinyl chloride, and polyethylene. Further, in some embodiments the polymeric material is a hybrid material including both a polymer and a magnetic material, such as pellets including both the polymer and the magnetic material. In the hybrid material, the magnetic material also may comprise, consists of, or consist essentially of pure Sm₂Fe₁₇N₃ (Sm—Fe—N).

In various embodiments, the content of the magnetic material in the mixture is at least approximately 95 percent by weight (wt. %), optionally at least approximately 96 wt. %, optionally at least approximately 97 wt. %, optionally at least approximately 98 wt. %, optionally in a range of from approximately 95 to 99 wt. %, optionally in a range of from approximately 95 to 98 wt. %, optionally in a range of from approximately 95 to 97 wt. % optionally in a range of from approximately 95 to 96 wt. %, optionally in a range of from approximately 96 to 99 wt. %, optionally in a range of from approximately 97 to 99 wt. %, optionally in a range of from approximately 98 to 99 wt. %, optionally in a range of from approximately 96 to 98 wt. %, optionally in a range of from approximately 96 to 97 wt. %. In specific embodiments, the content of the magnetic material in the mixture is approximately 95 wt. % (corresponding to approximately 74 vol. %), or alternatively approximately 97 wt. % (corresponding to approximately 81 vol. %).

The method next includes extruding the mixture. For example, the mixture may be extruded from a variety of extruder devices, such as, but not limited to, a twin screw extruder. The twin extruder may have, for example, a feed zone and a die zone. The feed zone may include a plurality of barrel elements that enclose the screws. The twin extruder may also include a temperature control system that allows for control of the temperature of the barrel elements and the die zone. The die zone includes one or more holes through which the mixture is extruded to obtain extrudates.

The method next includes compression molding the extrudates to obtain a compression molded product. The extrudates may be compression molded, for example, using a press such as, but not limited to, a hydraulic press, particularly a 30-ton hydraulic press. The hydraulic press may include upper and lower platens and a temperature control system that allows for the setting and control of the temperature of the upper and lower platens. Pressing of the extrudates between the upper and lower platens produces a high density compression molded product, which may be, for example, in the form of a flat plate, or alternatively another shape formed by compression molding.

The method may also include annealing the compression molded product in a magnetic field. For example, the magnetic field may have a magnetic flux density of up to 5T, optionally in a range of from 1 to 5T, optionally from 2 to 5T, optionally from 3 to 5T, optionally from 4 to 5T, optionally from 2 to 4T, optionally from 2 to 3T, optionally from 3 to 4T. In certain embodiments, the magnetic flux density is approximately 3T.

The compression molded product may have a maximum energy product (BHₘₐₓ) of at least 20 MGOe, optionally at least 21 MGOe, optionally at least 22 MGOe, optionally at least 23 MGOe, optionally in a range of from 20 to 24 MGOe, optionally from 21 to 24 MGOe, optionally from 22 to 24 MGOe, optionally from 23 to 24 MGOe, optionally from 20 to 23 MGOe, optionally from 20 to 22 MGOe³, optionally from 20 to 21 MGOe, optionally from 21 to 24 MGOe. In certain embodiments, the maximum energy product is approximately 21 MGOe, alternatively approximately 23 MGOe.

The compression molded product with post-magnetic field annealing may have a degree of alignment (DoA) of at least 90%, optionally at least 91%, optionally at least 92%, optionally at least 93%, optionally at least 94%, optionally at least 95%, optionally at least 96%, optionally at least 97%, optionally at least 98%, optionally at least 99%, optionally in a range of from 90 to 99%, optionally from 91 to 99%, optionally from 92 to 99%, optionally from 93 to 99%, optionally from 94 to 99%, optionally from 95 to 99%, optionally from 96 to 99%, optionally from 97 to 99%, optionally from 98 to 99%, optionally from 90 to 98%, optionally from 90 to 97%, optionally from 90 to 96%, optionally from 90 to 95%, optionally from 90 to 94%, optionally from 90 to 93%, optionally from 90 to 92%, optionally from 90 to 91%.

A high energy density bonded magnet formed by the method is also provided. The bonded magnet includes a critical rare earth free magnetic material and a polymeric material. The critical rare earth free magnetic material may include or essentially may be Sm₂Fe₁₇N₃ (Sm—Fe—N). The polymeric material may be a polymer or combination of polymers selected from the group of polyamides, polycarbonates, polyphenylene sulfides, polyether ether ketones, polyurethanes, polytetrafluoroethylenes, thermoplastic elastomers, polyvinyl chlorides, and polyethylenes. The content of the critical rare earth free magnetic material may be in a range of approximately 95 to 97 wt. %, optionally approximately 95 wt. %, optionally approximately 97 wt. %.

While the method disclosed herein is described with reference to Sm—Fe—N magnets, may also be applied to other permanent magnet compositions such as Dy, Tb-free Nd—Fe—B, La, Ce doped Sm—Fe—N magnets.

### EXAMPLES

The present method is further described in connection with the following laboratory examples, which are intended to be non-limiting.

Composite pellets of Sm—Fe—N(obtained from Nichia Corporation; AL16 grade) in PA12 polymer were mixed with pure Sm—Fe—N powders (obtained from Nichia Corporation) and compounded using a batch mixing, followed by compression molding. The starting magnet weight fraction of the as-received Sm—Fe—N/PA12 pellets was 93%. The as-received pellets are added to the batch mixer and allowed to melt. Pure Sm—Fe—N powders are then added to the melt and allowed to disperse. Different ratios of powders are added to achieve the desired weight fractions of 95% (sample #S1) and 97% (sample #S2). Thus, Sm—Fe—N bonded magnets were fabricated with two different wt. % of magnetic powder loading i.e. 95 wt. % (74 vol %), and 97 wt. % (81 vol %) and were denoted as S1 and S2, respectively. The batch mixed compound did not require a significant residence time in the batch mixer to form a homogeneous mixture. Lower residence time indicated less specific energy requirements regarding mixing, and thus could make scaling up to large scale processes easier.

The magnetic hysteresis loops of both the as-compressed and post-fabrication magnetic field aligned bonded magnets were measured from 20-400 K using a Quantum Design SQUID magnetometer. X-ray powder diffraction of the as-compressed bonded magnets was performed with a Bruker diffractometer using Cu—K_{α} radiation to study the structural analysis of the samples. Thermogravimetric analysis (TGA) measurements were performed using a Q50-1665 TA analyzer to determine the amount of magnet material present in these samples. Extruded pellets weighing about 35 mg were placed in a platinum crucible and heated from room temperature to 700° C. at 10° ·min⁻¹ in flowing nitrogen gas. Morphologies of the bonded magnets were examined using a scanning electron microscopy (SEM). By following standard metallographic sample preparation methods, bonded magnets were surface mounted in a resin and allowed to dry overnight. Then, the surface of the bonded magnets was ground and polished until it was smooth, gold coated and ready for imaging. Nano hardness indentation on S1 and S2 were measured to determine the strengths of the compression molded samples. The testing was conducted using a TI 950 TriboIndenter (Hysitron Incorporated). Macro-level strength evaluation was determined by measuring Vickers hardness using a Wilson VH1202 microhardness tester (Buehler, Lake Bluff, Illinois) with a load of 0.5 kg and a dwell time of 10 seconds. Magnetic hysteresis loops of the as-fabricated bonded magnets were measured at 300 K for each sample prior to in-situ alignment in a SQUID magnetometer. Samples were then heated at temperature, Tᵢ(300 to 512 K), in a magnetic field, Hᵢ, soaked for 5 minutes at Tᵢ, with the magnetic field still being applied, and then cooled down to 300 K, where magnetic hysteresis loops were measured again. For each alignment magnetic field strength (0.5, 1, 1.5, 2, 3, 4, 5, 7.5, 10, 20, 30, 40 and 50 kOe), samples were heated to the alignment temperatures, T=512 K at 12 deg·min⁻¹. Afterwards, hysteresis loop measurements were carried out at temperatures between 20 to 400 K.

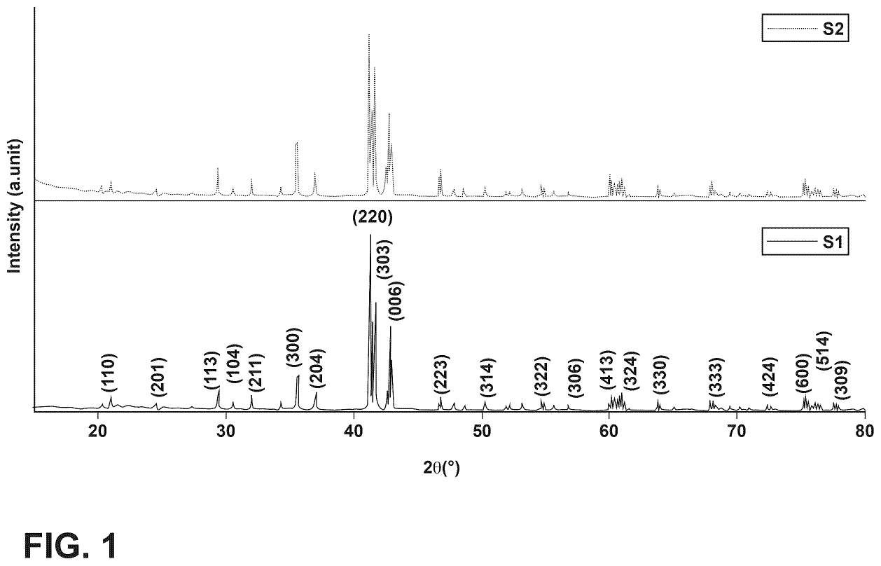

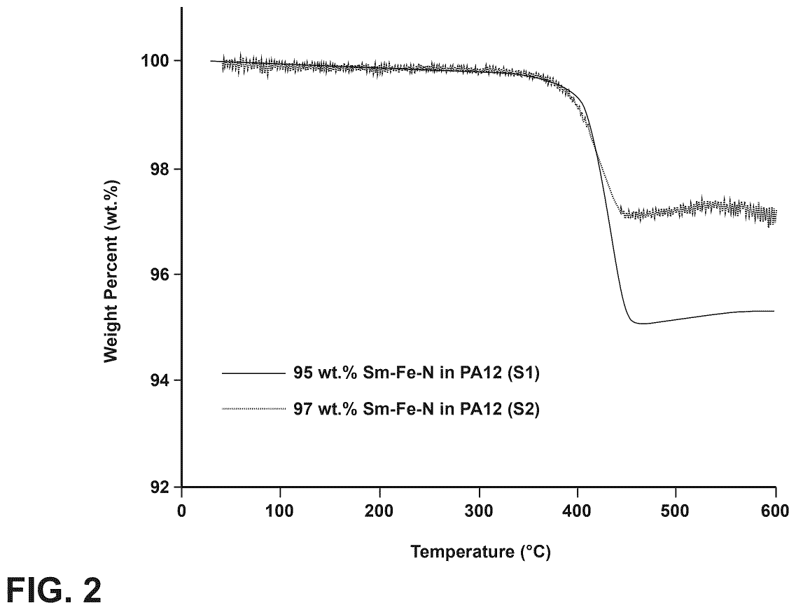

FIG. 1 shows the XRD patterns of the as-fabricated bonded magnets which indicate that the Sm₂Fe₁₇N₃ phase is preserved, without the other undesired phases such as SmN, α-Fe, and oxide phases, in contrast to other fabrication techniques. Hence, the extrusion-compression molding did not cause any degradation of the main phase of the initial magnetic powder. The density values of S1 and S2 are 5.3 and 5.2 g·cm⁻³, respectively (see Table 1 below). The lower density of S2 indicates a higher void fraction in the magnet. FIG. 2 shows the TGA results of the as-fabricated bonded magnets. The SEM images indicated the presence of 3-5 μm size Sm—Fe—N particles in PA12 polymer matrix. Vickers hardness and Surface area hardness measurements for S1 and S2 samples are 52.24 HV (515.6 MPa) and 38.98 HV (384.7 MPa), respectively. These results indicate that sample S1 is much stronger compared to sample S2 due to its higher polymer binder content leading to better consolidation of the resultant composite, as seen by the higher density observed in S1.

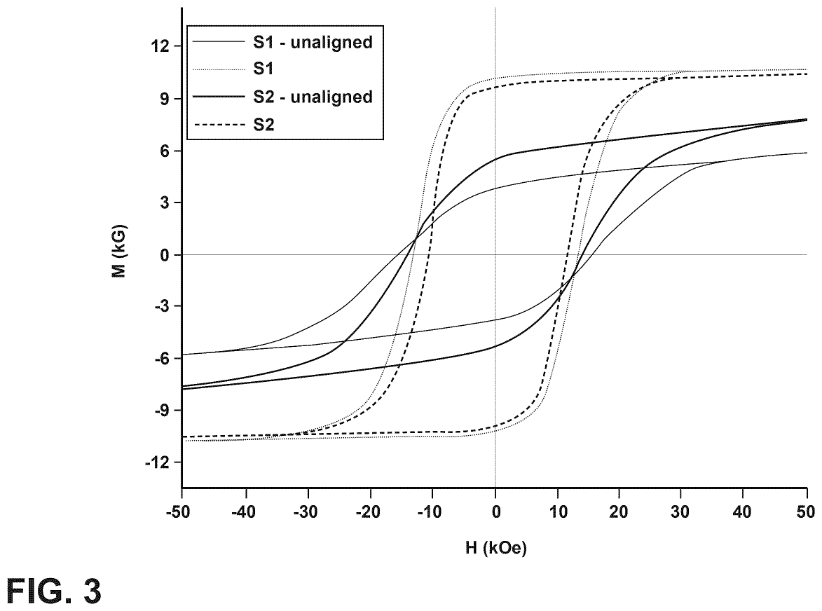

FIG. 3 shows the magnetic hysteresis loops of the two Sm—Fe—N bonded magnet samples S1 and S2, before and after magnetic alignment. The as-fabricated bonded magnets have non-saturating hysteresis loops, indicative of the lack of alignments of the magnet particles, which was confirmed by Degree of Alignment (DoA) analysis performed on S1 and S2. However, after magnetic alignment, changes in coercivity, remanent magnetization and saturation magnetization were observed. As the loading fraction of the aligned particles increased, the coercivity values decreased.

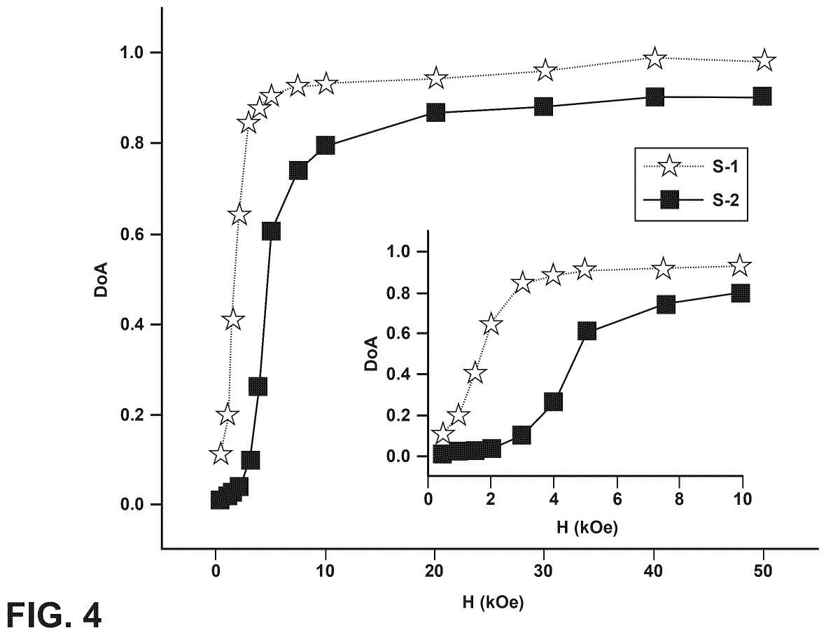

Sample S1 attained the highest remanent magnetization (10.1 kG) due to better alignment and higher density, compared to S2 (9.7 kG). The degree of alignment (DoA) is defined by the following Equation (1):

$$DoA = \frac{2 \times [ {M}_{r} ( A ) - {M}_{r} ( R ) ]}{{M}_{r} ( A )} \qquad ( 1 )$$

where (A) is the remanence after alignment and (R) is the remanence for randomly distributed particles. DoA is used to compare the effect of particle alignment at different fields. A maximum DoA value of 99% was achieved in S1, while S2 had a value of 90%. As shown in FIG. 4, the DoA increased with alignment magnetic field. It increased most significantly up to H=10 kOe and did not change significantly afterwards, which indicated the potential to integrate a low-field source into the bonded magnet fabrication process for in-situ alignment.

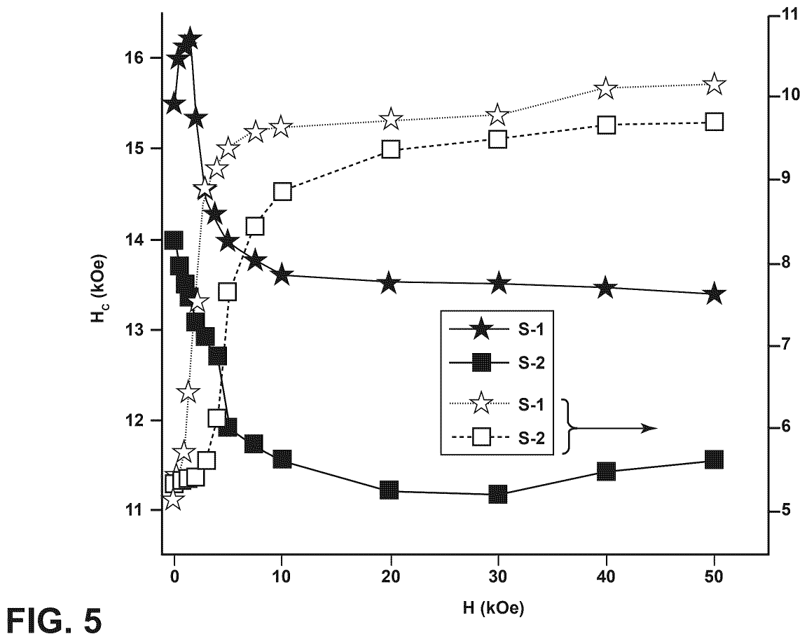

The DoA dependence on applied field, in initial field DoA increased more slowly for sample S2, compared to samples S1 (see the inset of FIG. 5). As magnetic field is applied to align the particles, three types of interactions are present: (1) interaction between the polymer binder (PA12) and magnetic particles; (2) the interaction between the applied magnetic field and magnetic particles; and (3) magnetic particle-to-particle interaction. The alignment is highly influenced by the respective interaction dominance. The initial slower change in DoA as a function of applied magnetic field for sample S2 can be attributed to the contribution of the higher loading fraction to enhancing the dominance of particle-to-particle interactions. This reduces the effective work done by the applied magnetic field to align the particles, hence the initial slower change in DoA. For S1, due to the low loading fraction, the interaction between polymer and particles dominates over other interactions. In this case, S1 may need less field to overcome the polymer to particles interaction to achieve maximum alignment. However, the resultant work done by of all three interactions in S1 improved DoA. FIG. 5 shows the dependence of the remanent magnetization and coercivity on the alignment field. It is evident that remanent magnetization follows the same trend as DoA for both samples. However, the coercivity shows very interesting behavior with S1 possessing the highest coercivity.

This behavior in the DoA indicates that the magnetization reversal mechanism is dominated by coherent rotation at lower loading fraction. Any interactions present in the system will alter the reversal mechanism to incoherent magnetization rotation with lower coercivity. The dependence of coercivity on the alignment magnetic fields are plotted in FIG. 5. For S1 and S2, the coercivity is either constant or shows small increments until 2 kOe alignment field. Afterwards, the coercivity decreases rapidly until 10 kOe alignment field and remains fairly unchanged at higher alignment fields. Two mechanisms affect the dependence of coercivity on the degree of alignment. The Stoner-Wohlfarth mechanism (Equation (2)) assumes a coherent rotation, which is applicable for non-interacting single domain particle sizes such that the effect of domain wall pinning is negligible. g(θ) is the angular dependence of coercivity on magnetic field applied at an angle θ from the easy axis. The dependence of coercivity on the degree of alignment in case of domain wall pinning (Kondorski mechanism) is shown in Equation 3. Depending on the alignment conditions, the effect of either of the mechanisms can dominate.

$$g ( θ ) = \frac{1}{( sin \frac{2}{3} ( θ ) + cos \frac{2}{3} ( θ ) ) \frac{3}{2}} \qquad ( 2 )$$

$$g ( θ ) = \frac{1}{cos ( θ )} \qquad ( 3 )$$

In the present samples, due to the existence of anisotropic powders with a wide distribution of particle sizes, the dependence of coercivity on the degree of alignment is a combination of Stoner-Wohlfarth and Kondorski mechanisms. The increment in coercivity at lower fields for S1 indicated that the Stoner-Wohlfarth mechanism dominates due to low interparticle interactions. Nevertheless, as the magnetic field increased beyond 2 kOe, coercivity started to decrease until the change became negligible due to the Kondorski mechanism. In the case of S2, though the increase in loading fraction is 2 wt. %, the coercivity decreased until the 10 kOe field, after which the change in coercivity became negligible. This may be explained by the Kondorski mechanism, in which interparticle interactions dominate.

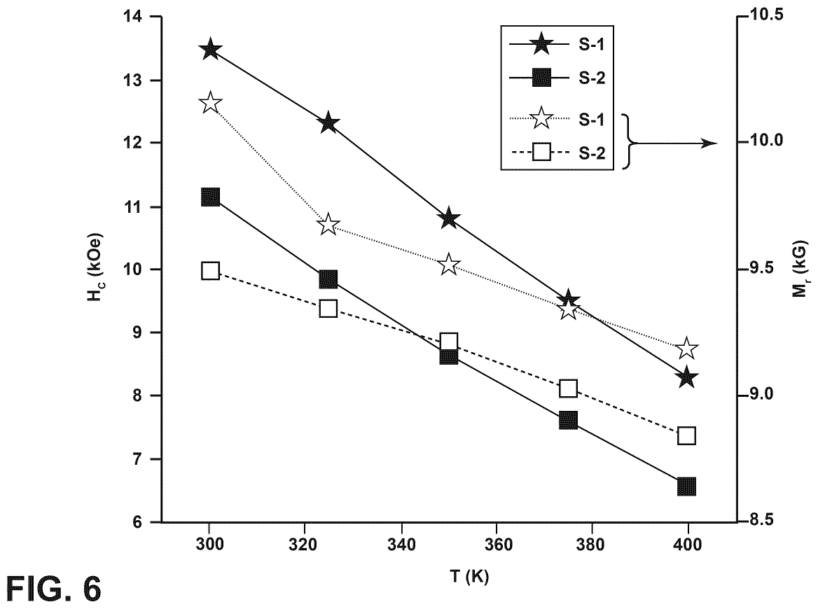

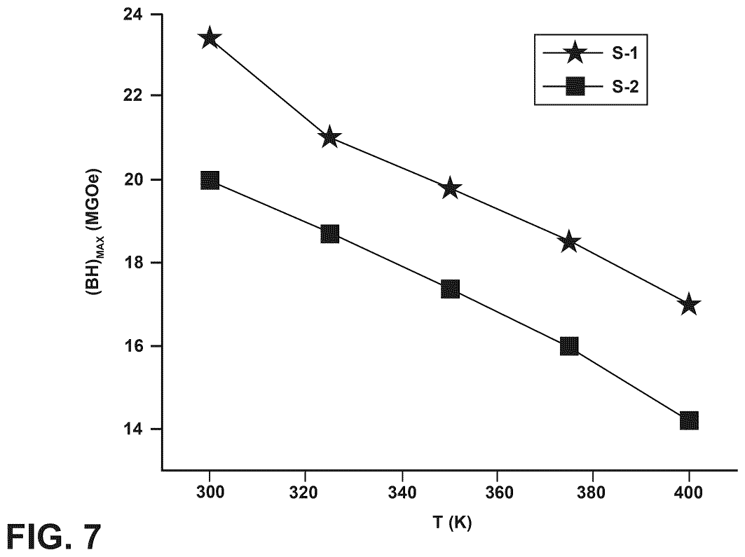

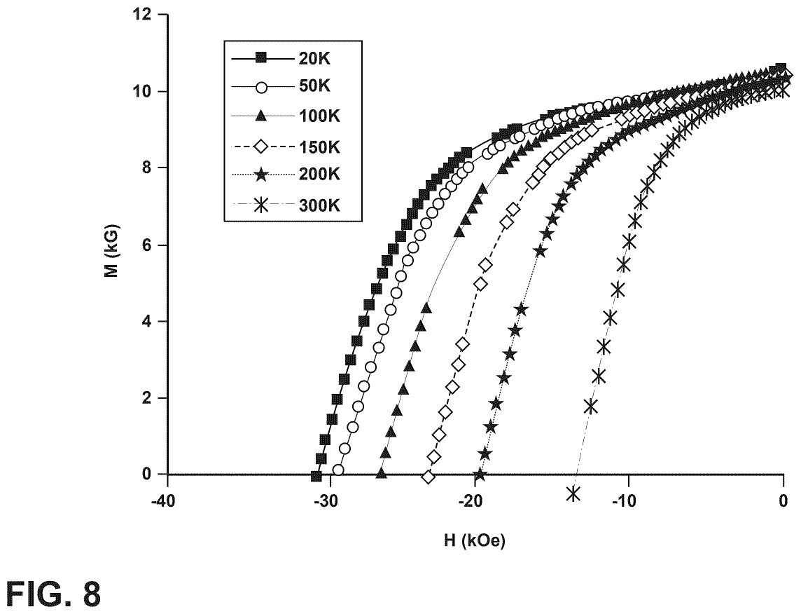

The data for the temperature dependence of coercivity and remanence are shown in FIG. 6. The irreversible losses in the hard magnetic properties of the compression molded magnets were characterized by temperature coefficients of remanence Br, α (%/K), and coercivity H_{c}, β (%/K), obtained between 300 and 400 K (see Table 1 below). The values showed that both samples have similar thermal stability. FIG. 7 shows the temperature dependence of the change in energy product. As the temperature increased from 300 to 400 K, due to thermal energy coercivity and hence the energy product decreased. The second quadrant of S1 at low temperature to 20 K is shown in FIG. 8. It is evident that the S1 sample was very stable even at 20 K and did not show any spin reorientation characteristics at low temperature. Hence, this magnet can successfully be used at low temperatures as well.

TABLE 1
Loading wt. %, Density, Energy Product (BH)max,
Degree of Alignment (DoA) and Thermal Coefficient
α %/K and β %/K for Samples S1 and S2.

| | Mag | | (BH)ₘₐₓ | | | |
|---|---|---|---|---|---|---|
| | powder | | kJ· m⁻³ | | | |
| Sam- | loading | Density | (MGOe), | | | |
| ple | wt. % | (g · cm⁻³) | 300K | DoA % | α % | β % |
| S1 | 95 | 5.3 | 186.21 (23.4) | 99 | −0.41 | −0.068 |
| S2 | 97 | 5.2 | 165.52 (20.8) | 90 | −0.41 | −0.068 |

The above description is that of current embodiments of the invention. Various alterations and changes can be made without departing from the spirit and broader aspects of the invention as defined in the appended claims, which are to be interpreted in accordance with the principles of patent law including the doctrine of equivalents. This disclosure is presented for illustrative purposes and should not be interpreted as an exhaustive description of all embodiments of the invention or to limit the scope of the claims to the specific elements illustrated or described in connection with these embodiments. For example, and without limitation, any individual element(s) of the described invention may be replaced by alternative elements that provide substantially similar functionality or otherwise provide adequate operation. This includes, for example, presently known alternative elements, such as those that might be currently known to one skilled in the art, and alternative elements that may be developed in the future, such as those that one skilled in the art might, upon development, recognize as an alternative. Further, the disclosed embodiments include a plurality of features that are described in concert and that might cooperatively provide a collection of benefits. The present invention is not limited to only those embodiments that include all of these features or that provide all of the stated benefits, except to the extent otherwise expressly set forth in the issued claims. Any reference to claim elements in the singular, for example, using the articles “a,” “an,” “the” or “said,” is not to be construed as limiting the element to the singular.

What is claimed is:

1. A method of fabricating a high energy density bonded magnet, the method comprising:
combining a critical rare earth free magnetic material with a polymeric material to obtain a mixture;
extruding the mixture; and
compression molding the extruded mixture to obtain a compression molded product.

2. The method of claim 1, wherein the critical rare earth free magnetic material comprises Sm₂Fe₁₇N₃ (Sm—Fe—N).

3. The method of claim 1, wherein the polymeric material comprises a polymer.

4. The method of claim 3, wherein the polymer is a polyamide.

5. The method of claim 4, wherein the polyamide is nylon 12.

6. The method of claim 3, where the polymer is polycarbonate, polyphenylene sulfide, polyether ether ketone, polyurethane, polytetrafluoroethylene, thermoplastic elastomers, polyvinyl chloride, or polyethylene.

7. The method of claim 1, wherein the polymeric material is a hybrid material including a polymer and a magnetic material.

8. The method of claim 7, wherein the magnetic material is Sm₂Fe₁₇N₃ (Sm—Fe—N).

9. The method of claim 1, wherein the mixture has a content of magnetic material that is at least 95 percent by weight (wt. %).

10. The method of claim 9, wherein the content of magnetic material is approximately 95 wt. %.

11. The method of claim 9, wherein the content of magnetic material is approximately 97 wt. %.

12. The method of claim 1, wherein the method further comprises annealing the compression molded product in a magnetic field.

13. The method of claim 12, wherein the magnetic field has a magnetic flux density of up to 5T.

14. The method of claim 13, wherein the magnetic field has a magnetic flux density of approximately 3T.

15. The method of claim 1, wherein the compression molded product has a maximum energy product (BHₘₐₓ) of at least 20 MGOe.

16. The method of claim 15, wherein the compression molded product has a maximum energy product (BHₘₐₓ) of at least 23 MGOe.

17. The method of claim 12, wherein the compression molded product with post-magnetic field annealing has a degree of alignment (DoA) of at least 90%.

18. The method of claim 17, wherein the compression molded product with post-magnetic field annealing has a degree of alignment (DoA) of at least 99%.

19. A high energy density bonded magnet formed by the method of claim 1.
